(19) United States
(12) Patent Application Publication
(10) Pub. No.: US 2023/0245231 A1
(43) Pub. Date: Aug. 3, 2023

(54) SYSTEMS AND METHODS FOR PROVIDING LOW RISK ASSET-BASED INVESTMENT PRODUCTS

(71) Applicant: Nicolas Teissier, Salon-de-Provence (FR)

(72) Inventor: Nicolas Teissier, Salon-de-Provence (FR)

(21) Appl. No.: 18/059,512

(22) Filed: Nov. 29, 2022

Related U.S. Application Data
(60) Provisional application No. 63/306,259, filed on Feb. 3, 2022.
(60) Provisional application No. 63/347,391, filed on May 31, 2022.

(51) Int. Cl. G06Q 40/06; G06Q 50/16

(52) U.S. Cl. CPC G06Q 40/06; G06Q 50/167; G06Q 2220/00

(57) ABSTRACT

Asset-based investment product can be created out of any activity or asset that may generate income. These securities can be created out of any movable or immovable property, tangible assets, or intangible assets such as NFTs. Such an investment product can focus on long-lasting value classes of assets, such as real estate, as long as they can generate income and/or are subjected to long-lasting value appreciation or sustainability. In at least one embodiment, such an asset-based investment product will only pool “safe parts” of assets, can create “safe part tokens” or their equivalent out of these assets, and can offer senior tranches level to investors acquiring those “safe part tokens.” These senior tranches may be rewarded more than junior tranches after the “safe part” of each of the underlying assets has been bought, described, and registered in the blockchain owned or used by the asset holder or its beneficiaries.

### CLAIM OF PRIORITY

This application claims the benefit of both U.S. Provisional Application No. 63/306,259 (Attorney Docket No. 776201.000001) titled “SYSTEMS AND METHODS FOR PROVIDING ASSET-BACKED SECURITIES,” filed Feb. 3, 2022 and U.S. Provisional Application No. 63/347,391 (Attorney Docket No. 776201.000002) titled “SYSTEMS AND METHODS FOR PROVIDING ASSET-BACKED SECURITIES,” filed May 31, 2022, the entire contents of which is incorporated herein by reference.

### FIELD OF THE DISCLOSURE

The present disclosure relates to systems and methods for providing low risk asset-based investment products out of any activity or asset that may generate income, including assets that include movable or immovable property, tangible assets, or intangible assets such as non-fungible tokens (NFTs).

### BACKGROUND

In a context such as negative interest rates, inflation, raising indebtedness of the states, saving money has become less rewarding than investing the money in the real economy, or into lasting value assets and/or sustainable assets, real estate, businesses, the financial markets, cryptocurrencies, crypto-assets, or NFTs.

The spread between monetary growth and economic growth has increased, and in the same time: velocity of currencies, confidence in their stability, transparency and the ability of governments and central banks to maintain their value over time have decreased in the wake of the 2008 economic and financial turmoil, indebtedness of the states, Covid crises and competition created, among other things, by cryptocurrencies, while inflation increases any time central banks and states invest in their economic zones in order to counterattack the effects of economic slowdowns, or sanitary crises.

Negative interest rates and inflation that happened at the same time in 2021-2022 represent a major malfunction of the principles of the “Economic Growth” as we have experienced it since the end of World War II and the era of mass consumption, in a context of limited natural and environmental resources and climate change. Incentives implemented today in order to create an economic growth or to contain the effect of the Covid crises at any cost will most certainly turn out creating greater declines on some markets, values and currencies in the mid-term as most goods and services are concerned by inflation, without distinction of value between them.

On the contrary, some lasting-value assets such as real-estate properties or sustainable resources and even NFT or crypto-assets that are also facing inflation today, will have the capacity to replace some fiat currency or bonds as safe haven values. These assets could, directly or indirectly, be at the center of value creation and contribute to more innovative, collaborative and more transparent ways of financing the economy.

In this context, it is logical that when these long-lasting values are used as an investment or a collateral, they should be rewarded more than saving money or non-lasting values.

### BRIEF DESCRIPTION OF THE DRAWINGS

Various embodiments in accordance with the present disclosure will be described with reference to the drawings, in which:

FIG. 1 illustrates an example asset information management system that can be utilized in accordance with various embodiments.

FIG. 2 illustrates an example process for utilizing an authentication service that can be utilized in accordance with various embodiments.

FIG. 3 illustrates an example process for updating information stored in a distributed ledger that can be utilized in accordance with various embodiments.

FIG. 4 illustrates an example process for registering descriptions in a blockchain that can be utilized in accordance with various embodiments.

FIG. 5 illustrates an example process for rewarding holders of registered tokens that can be utilized in accordance with various embodiments.

FIG. 6 illustrates an example process for issuing asset-based investment products that can be utilized in accordance with various embodiments.

FIG. 7 illustrates example components of a computing device that can be used to implement aspects of various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

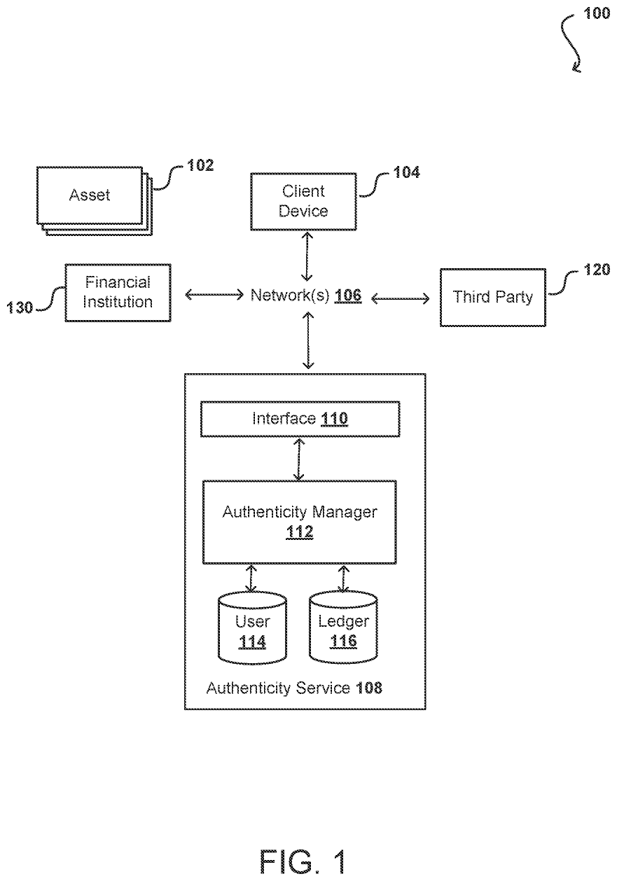

FIG. 1 illustrates components of an example asset information management system 100 in accordance with at least one embodiment. It should be understood that this is just one example for purposes of explanation, and there can be various other components and configurations utilized within the scope of the various embodiments and discussed and suggested herein.

A user of such a system might have various assets 102 that may have at least some monetary value. These may include, for example, any movable or immovable property, tangible assets, or intangible assets, such as NFTs, among other such options, which may include watches, vehicles, intellectual property, real estate, and the like. In other situations a user may want to acquire or otherwise engage in a transaction involving such assets.

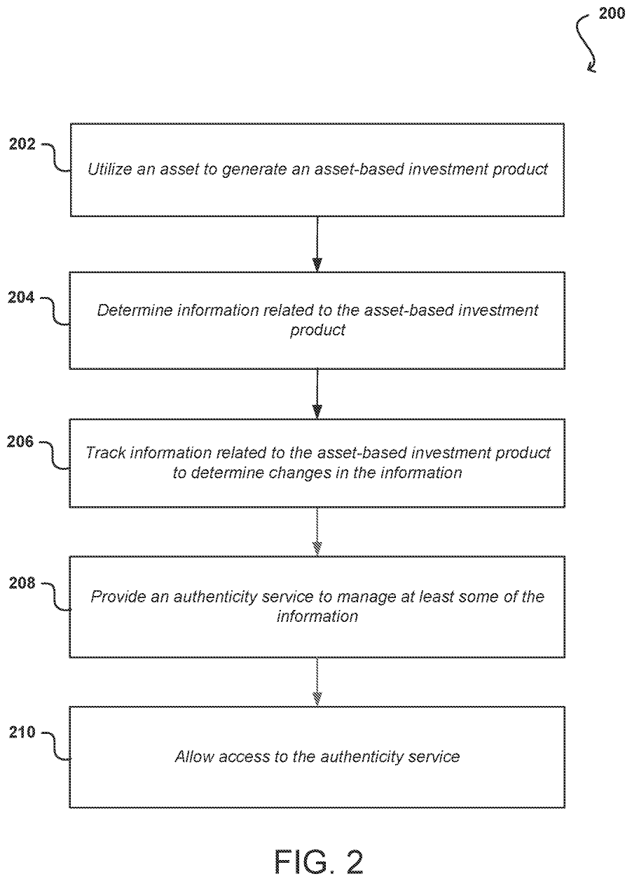

FIG. 2 illustrates an example process 200 for utilizing an authentication service. Approaches in accordance with various embodiments can leverage the power of distributed ledgers, such as blockchains or NFTs. In at least one embodiment, an entity can utilize an asset, particularly an asset of a class having long-lasting value such as real estate, to generate or obtain an asset-based investment product 202. Such a system can also determine 204 and track 206 information such as authenticity, ownership, condition, service history, market value, and other such information about this investment product. In at least one embodiment, a service provider might provide an authenticity service 108 that can manage at least some of this information 208. The authenticity service 108 may manage at least some of the information using an authenticity manager 112. A user having an asset can utilize a client device 104 to access 210 the authenticity service 108 over at least one network 106 through an interface 110. Similarly, third parties 120 and financial institutions 130 may access 210 the authenticity service 108 over at least one network 106. The client device 104 can be any appropriate client device, such as a desktop or notebook computer, tablet, smartphone, wearable computer, or other such device. The network(s) 106 can include any appropriate network, such as a cellular network, Internet, local area network, peer network, or any other wired and/or wireless communication network. An authenticity service 108 can include any appropriate set of computing components, such as may include servers, routers, load balancers, interfaces, storage devices, and other such components for tasks such as receiving, managing, and processing data.

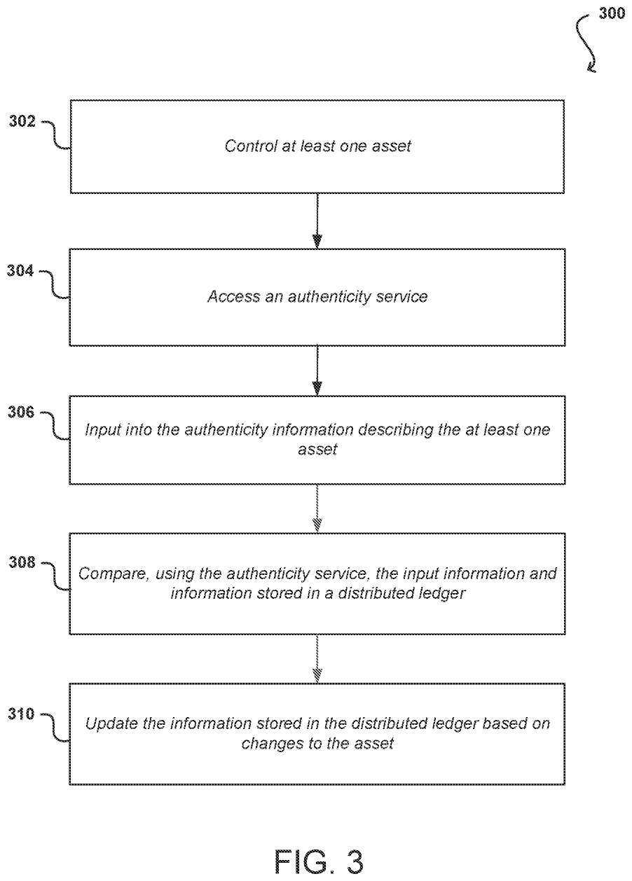

FIG. 3 illustrates an example process 300 for updating information stored in a distributed ledger. As an example, a user might purchase or own a parcel of real estate 302. In one example, the user can utilize a client device 104 to access 304 the authenticity service 108 through an interface 110, such as through an electronic application or a website. The user can input information about the real estate, such as address and title information 306. The authenticity service 108 can check information in a distributed ledger 116 using the authenticity manager 112 to determine whether the service stores information for that parcel, or asset. The service can use this information to verify information about the asset using the authenticity manager 112, such as to confirm 308 its existence, any chain of title, or other such information, which may already be stored in a distributed ledger 116. In another example, when an asset is sold by an entity, that entity may send information to the authenticity service 108 indicating that the asset exists with certain information, and may include information about the transaction and/or purchaser. The authenticity manager 112 can authenticate at least some of the information. Any or all of this information can be used to generate or update 310 a distributed ledger 116 to which the authenticity service 108 has access. The authenticity service 108 can also store user information 114 for its various users, and can link those users to their various assets. Once an authenticity service 108 has this information, this information can be utilized for various purposes.

Entities such as financial institutions 130, banks, and lenders often use assets 102 such as real estate property as collateral for mortgage loans when individuals or businesses do not fit various revenue criteria. When doing so, they often use part of the asset market value to determine the maximum amount of credit granted. In the case of a mortgage, for example, this secured or “safe” portion” of the asset value often represents 60% of the market price in real estate, and can give access to an additional source of funding when individuals do not meet debt sustainability criteria. Companies can also use this mechanism when they have insufficient cash flow and need to find additional funding.

As an example, if an individual owns a house at a market price of $350,000, a lender may provide an loan for $210,000, 60% of the market price, against the collateral offered by this “safe” portion or safe part of the asset. In some embodiments, the safe part of the asset may also be a low-risk portion of the asset or in certain embodiments the least variable part of the asset in relation to market volatility. In doing so, the lender or financial institution, who may be willing to minimize risks to avoid foreclosure and maximize profit, may also officialize that $1 of this safe portion has a minimum value of $1, and that $1 of the “unsafe” portion of the asset is worth potentially nothing when it comes to funding, risk, or investment. If one considers using the same asset for investment purposes instead of funding, it means that the safe part worth $210,000, that generates more value in a mortgage process, should be worth much more than the unsafe part of the asset (40% in the banking system valuation) in an investment perspective and potentially 100% of the market valuation of the asset.

The following paragraphs describe various embodiments presenting new kinds/forms of asset-based investment products that distinguish themselves from the functioning of any existing securities, such as asset-backed securities (ABS), on several levels. An example asset-based investment products described herein will mainly focus on long-lasting value class of assets like real estate, as mentioned previously, although it should be understood that there is no real limitation to the classes of assets that can be concerned by the following.

In some embodiments, contrary to the usual mode of operating of an existing investment product, such as ABS, an asset-based investment product as described may only pool “safe parts” of assets, may create “safe part tokens” or their equivalent out of them. Additionally, the asset-based investment product may offer senior tranches yield levels to investors acquiring those “safe part tokens”.

In some embodiments, contrary to the usual mode of operating an existing investment product, these senior tranches may be rewarded more than junior tranches after the “safe part” of each of the underlying assets has been bought, described, and registered in a proprietary or non-proprietary blockchain. The proprietary blockchain may be owned and/or used by a controlling entity, or the entity's beneficiaries, which have rights to the proprietary blockchain or the information underlying the proprietary blockchain.

In some cases, for example a French Fiduciae type of contract where a controlling entity would act as the fiduciary, the unsafe part of the asset might not be paid instantly by the controlling entity and remain partially the property of the former owner of the asset for a period of time, before the asset is sold. The controlling entity could choose to create and/or use any type of company or investment company in order to buy the assets, based on the sales specificities in terms of timing or other requirements. For instance, in the real estate example, depending on the market opportunity, the company or entity could be a real estate investment trust (REIT), or real estate investment funds such as real estate mutual funds, real estate private equity funds, real estate exchange-traded funds (ETFs) or a special limited partnership.

When one asset is bought, the contract may indicate that a controlling entity will pay and/or acquire the entirety of the asset at a specific time, indicated in a predefined phased schedule. The first phase can involve the definitive and immediate payment of the safe part of the asset, with the second phase of payment being postponed to a later stage coinciding with the anticipated date of sale of the considered asset. The contract can be in any of various different forms, such as to use a smart contract in addition to more classic type of contract or to replace more classic types of contract. The contract may also indicate that for some specific class of assets or assets, the second phase of payment due, and based on the global price of the asset determined at the beginning of the process minus the payment of the first phase, will happen only when the asset is sold by the controlling entity or after an agreed-upon period of time.

In such a situation, or when the date of sale is predefined and fixed in the contract, the asset seller could benefit from a specific interest paid monthly, quarterly or annually, as a compensation for not being able to be paid entirely when the asset is transferred to the controlling entity. The yield allocated to the former owner of the asset, that could also be considered as a co-owner for a specific amount of time or as a contracting party, would correspond to the part of the revenues generated by the asset management operated by a controlling entity through a specific organization or company, but will be lower that the yield offered to investors acquiring a part or the entirety of the “safe part” of the asset that could take the form of “safe part tokens”. This compensation can correspond to the junior tranche of the asset.

In some other cases, the asset might entirely be owned or acquired immediately by a controlling entity who will detail, describe, and register the “safe part” value of the asset as one or more entries in the blockchain. In addition to the asset management fees, the controlling entity could also be rewarded with the same junior tranches for owning the “unsafe part” of the asset and would benefit from a lower yield on these junior tranches than the one offered to senior tranches directly issued from the “safe part” value of the asset registered in the blockchain.

In some other cases, the controlling entity could settle a vendor-credit type of contract to buy the asset with an up-front payment corresponding to the safe part value (or low risk portion value) of the asset, and installments corresponding to the financing of the unsafe value of the asset over a multi-year period. In this scenario, the installments and the interest payed by the controlling entity to the seller would probably be aligned with the market level offered by the banks and would be inferior to the junior tranche of yield described in the previous paragraph.

After proceeding with the identification, description and registration of the “safe part” of the asset value and characteristics in the blockchain, the controlling entity can issue “safe part tokens”, equivalent to shares or interests of a fund, representing a portion of the entire safe part value of all the assets registered in the blockchain.

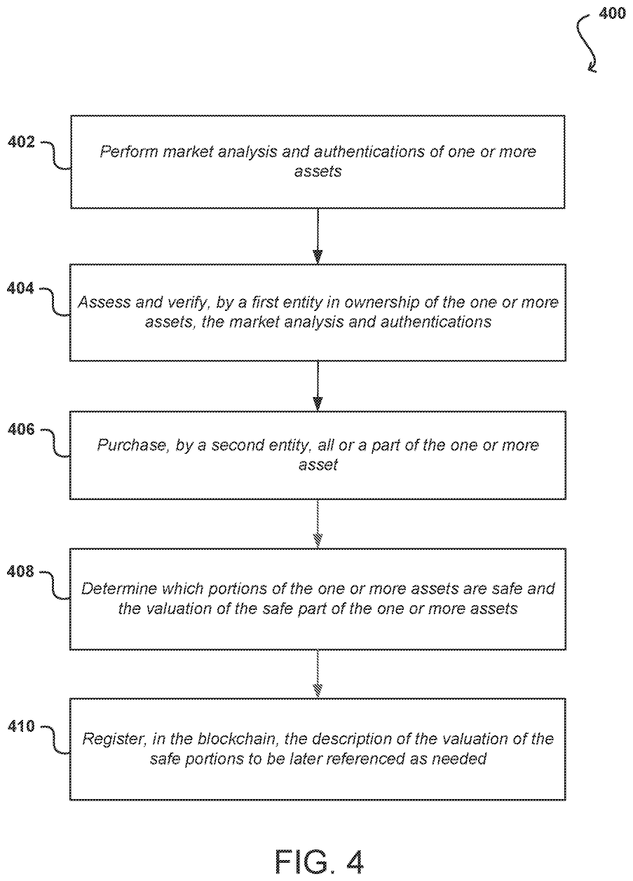

FIG. 4 illustrates an example process 400 for registering descriptions in a blockchain. After specific market analyses and authentications 402 have been assessed and verified 404, such as by the controlling entity or a subcontractor specialized in this field, a second party can buy or acquire 406 all or part of an asset and determine which part can be considered as safe by taking into account inflation, market dynamics, the discounted cash flows of that asset, and so on. The description of the valuation of the safe part of one asset can be determined 408 by experts hired by the controlling entity, or can be bought when existing, and will systematically be registered 410 in the proprietary blockchain owned or used by the controlling entity or a non-proprietary blockchain, as the source of the valuation. Sometimes, the valuation method will only be based on lenders habits or the market standards and will be described and registered as such in the blockchain. For each class of asset, algorithms may be used or created in partnership with third parties or developed specifically to calculate the right portion of an asset the “safe part” represents and the corresponding price and/or value. Valuation could synthetize both the present time, short term, middle term and/or long term values by using discounted cash flows type of methods of valuation. Algorithms will take several factors into account, as may include but are not limited to: past, current, and anticipated market prices, market size and anticipated consumer behaviors predictive evolution, country or area stability, sanitary exposure of the asset, sustainability of the asset, scarcity of the asset, utility of the asset compared to other class of assets, current level of inflation of currencies, cryptocurrencies and NFTs and predictive level of inflation, repartition of all the worlds money on the different markets, spread between monetary growth and economic growth, indebtedness of the states, climate change impact on the asset access, utility and value, and may take into account the weighting criteria of each factor to determine the entire “safe part” value of one asset.

In order to generate reliability, the value of all assets and each safe part of an asset within a specific class of asset may be valued using the same criteria and methodology.

After the value of each safe part of an asset has been determined and registered in a blockchain, owned or used by a controlling entity for this purpose, a specific process may be used to split the entire portfolio of safe parts of assets and its value into identical portions of shares of the fund or safe part tokens. Similar to a share of a fund, each “safe part token” acquired by an investor through a payment in fiat, cryptocurrency, or through a payment-in-kind will have a price fixed in fiat currency or in cryptocurrency.

Each safe part token, equivalent to a share of a fund, will represent a portion or a percentage of the value of all the safe parts of assets identified and registered as such in a non-proprietary blockchain or the proprietary blockchain owned or used by a controlling entity. Any time the number of assets and the number safe parts of assets registered in the blockchain evolves, the blockchain can be updated, and the percentage or portion of the value of all the safe parts of assets identified and registered as such in the blockchain and linked to the safe parts tokens or shares will be updated accordingly, both in the blockchain of the fund and in the net asset value (NAV).

The yield or valuation produced by a “safe part token” unit sold by a controlling entity, or any type of form of investment offered to acquire all or a portion of a safe part, will always be the same as any other safe part token sold at the same time and within a same class of asset. In some instances, an investor could choose to invest at different periods of time and pay a different price to acquire a safe part token (or share of the fund) depending on the NAV and benefit from a different type of yield or valuation and level of yield or valuation. In another instance, an investor could also invest in several asset classes that may have a different sale price from one another. A controlling entity could also create different types of investment products mixing the different classes of safe parts tokens and offer different levels of yield or valuation.

The existence of “safe parts” of assets, their division into “safe part tokens” equivalent to shares and their potential conversion into coins or any other type of investment forms and all the information detailing the ownership and the characteristics of these safe parts of assets, can be certified and registered in a proprietary or non-proprietary blockchain, and can remain accessible and available for security, immutability, transparency, and other such purposes.

In at least one embodiment, the safe parts of assets may be pooled and may lead to the issuance of safe part tokens equivalent to shares of an investment fund, or any other investment forms, available for both institutional and retail investors through smart contracts or any other form of contract. For these safe parts tokens or any other investment forms using the process and concept of the safe parts of assets to exist, certain conditions may be needed in at least one embodiment. In one example, a safe part of one asset can be pooled with other safe parts of assets of the same class of assets or even from other classes of assets. It can be fragmented into several safe part tokens, or any other equivalent type of investment form such as a share of a fund. A safe part of one asset will always benefit from a higher yield and/or valuation than the one obtained through the ownership of the unsafe part of this asset.

In an investment fund, after the safe part values of assets are registered in the blockchain at a price corresponding to a percentage of the purchase price of the assets they rely on (using the algorithm and/or valuation process to calculate it), the “safe part tokens” or shares of the fund sold to the investors will provide them with the right and the opportunity to benefit from the valuation of all the safe parts of assets registered in the fund's blockchain at a proportion defined by the number and the value of these shares or safe parts tokens, at the time they are acquired by them.

As described with the example described above regarding 60% of the market price as the safe part of the asset, the safe part value of an asset is defined as the portion of its market value that is considered as stable and incompressible, whereas the unsafe part of an asset's market price does not have a proper risk and investment value. The unsafe part of an asset can only create an opportunity to generate a potential additional yield but it is neither stable nor incompressible.

Therefore, should the entire safe part value of one real estate asset be valuated at 60% of the market price of this asset, registered in the blockchain and sold by an investment fund owned in the form of safe part tokens or shares of this fund and representing its entire value, this would indicate that the value of all the shares or of all the safe part tokens issued from this safe part of asset worth 60% of the market price of the asset bought by the fund and benefiting from the senior tranches, should be rewarded with at least 100% of the asset's valuation or of the fund's NAV. This would also indicate that, in the case of a major turmoil on the market causing a decrease of 40% in the market price of the asset compared to the price it has been purchased by the fund, the safe part tokens or shares of the fund, representing the entire asset value, would be worth the same value as the one they were purchased at.

In a scenario where the fund would buy an entire real estate asset at its market price, both the safe part and the unsafe part, the fund manager would need to define the safe part value of this asset and register it in the blockchain of the fund, before selling the shares or safe part tokens based only on the safe part of asset, to the investors. The fund would also need to finance the unsafe part of this asset with a different process of financing and compensation, which may include but are not limited to: offering only a junior tranche of yield with no access to the NAV, offering a temporary interest on the rental incomes with no access to the NAV, and a vendor credit as described in the previous paragraphs.

Only the “safe parts” of the assets registered in the ledger of the blockchain and pools of safe parts will lead to a “safe part token” issuance, or issuance of any other investment forms from the safe parts of assets.

Much of the time safe part tokens, which may be equivalent to shares of a fund, sold to investors will represent a portion of a pool of all the safe parts of assets registered in the blockchain. The safe part tokens can also be registered in the blockchain on which the initial portion of all safe parts of assets they are issued from initially will be registered. The blockchain can also reflect both the evolution, or development, of the valuation of the safe parts of assets' portfolio and the evolution of the valuation of the portfolio of assets and will be updated anytime a new safe part of asset is identified and registered as such in it. When the size of the portfolio of safe parts of assets increases, the blockchain can be updated and register the new portion of each safe part of asset associated with one “safe part token” or one share of the fund, depending on the acquisition price of this share or “safe part token”.

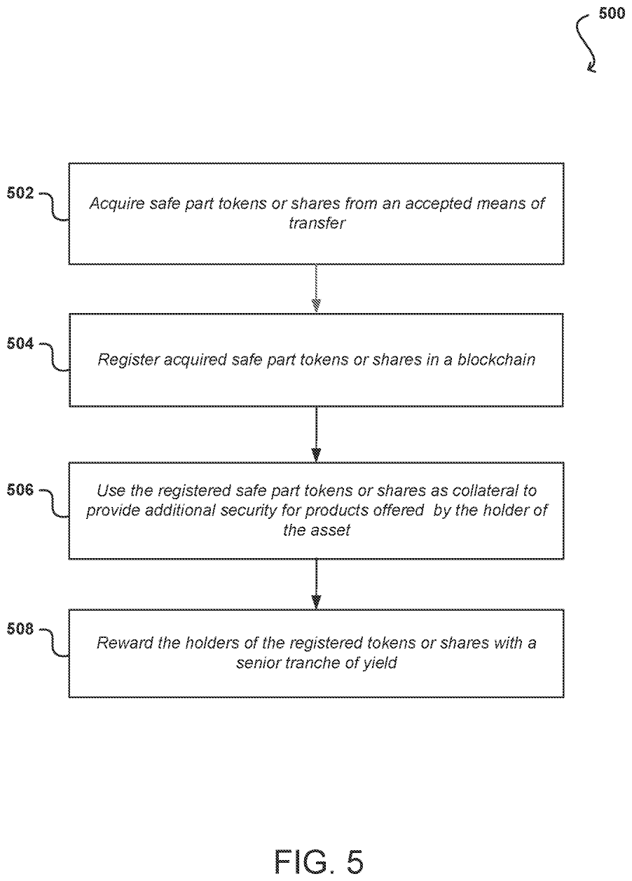

FIG. 5 illustrates an example process 500 for rewarding holders of registered tokens. Safe parts tokens may be acquired 502 and sold through an investment fund, or any other investment form, or a marketplace. In some embodiments, the fund investment for, or marketplace may be developed by a controlling entity. The fund or marketplace may be linked to a non-proprietary blockchain or a proprietary blockchain of the controlling entity. In another example, the controlling entity may partner with existing platforms and blockchains with the capacity to adapt to their needs.

The safe parts tokens, or shares, or any other type investment forms issued from the safe parts of assets, can always be registered in the blockchain 504. However, in some specific markets such as real estate, a controlling entity may use the French SCPI type of investment structure or its equivalent in other countries, like REITs, in order to facilitate tax optimization. In certain examples, the ownership of the safe parts tokens could be replaced and/or associated with shares offered by these type of companies or investment vehicles. In this situation, the shares acquired could also be registered as portions of safe parts of assets registered in the blockchain, where the safe parts tokens would be replaced by the shares, but the shares would function accordingly to the form of this type of fund. Registering the shares as portions of safe part of assets could still allow a controlling entity to use them as collaterals 506, in order to offer an additional security to asset-backed loans or any type of loans or investment product offered by the controlling entity, of the controlling entity's beneficiaries, partners, subcontractors, and/or third parties and to reward the shares with a senior tranche of yield 508.

The safe parts tokens equivalent to shares of a fund might also be used and sold on the financial markets as classic ABSs, such as CDOs, MDOs, or any other securities. The safe parts tokens can also be redistributed or commercialized by banks or financial institutions or be used to create new investment products or securities. The banks or financial institutions may obtain an agreement from a controlling entity that has rights to create new investment products or securities. The safe part tokens can also be used to create new investment products or securities. In some embodiments, holding a safe part token or a share issued from safe parts of assets will not authorize anyone to create new derivative products out of it without the agreement of a controlling entity.

As indicated in the former paragraphs, safe parts token owners can benefit from the senior tranches of yield/interest or valuation because at least some of the characteristics described in the previous paragraphs, which may include: they are safer, more trustworthy, and they also have more potential of creating value due to the asset management offered by the controlling entity or when assets are sold. Most of the time, senior tranches will be compensated at a variable rate depending of the profitability generated on the class of asset or through the valuations of the safe parts of assets portfolio and assets' portfolio. At the same time, while maintaining the quality of asset assessment, purchasing and sale management, the more the number of assets registered in a class of assets will grow and the more the yield distributed to the holders of safe parts tokens, or equivalent, or the valuation will be stabilized or enhanced and the risks will decrease.

In some embodiments, part of this value creation may also rely on the fact that each safe part of asset or portion of several safe parts of assets registered in the blockchain ledgers could be used as collaterals in order to offer an additional security to financing or investment solutions such as asset-backed loans or any type of loans or investment product offered. When doing so, each safe parts token can also benefit from senior tranches interest payments that will totally or partially be redistributed to the holders of safe parts tokens or shares.

Safe parts tokens may be used as collateral to invest in capital investment on some specific markets, in order to generate additional profit redistributed partially or totally to the token holders.

In at least one embodiment, the process of issuance of the safe parts of assets could also be used to identify the safe part value of any type of equity or revenue. Identifying the safe part value would allow for the determination of the safe ownership level (low risk portion ownership level) and price of an equity investment or to develop a revenue-based financing offer based on the safe part of the revenue. In certain embodiments, only a controlling entity may be able to determine the safe ownership level and price of an equity investment or to develop a revenue-based financing offer based on the safe part of the revenue. Both activities would function with an algorithm valuing the safe and sustainable value of an equity or of a revenue to determine an investment score or a credit score and allocate the right level of resources and investment. According to the safe parts tokens or shares process of issuance described in the previous paragraphs, after identifying the safe part of an equity or of a revenue and registering it in a blockchain, an investment fund could sell safe part tokens or shares in order to raise the necessary funding to invest in the safe part of an equity or to answer the financing needs of businesses or individuals.

These activities as well as all derivative products and activities that could be developed based on the safe parts registered in the blockchain ledgers or on the process of identification, registration and issuance of the safe part of assets and that may add additional revenues and/or yields to each safe parts token, coin or share, can only be created, developed, operated by the controlling entity or by an entity officially designated and authorized by the controlling entity.

In at least one embodiment the creation and use of a cryptocurrency may be based on the safe part tokens conversion or exchange. Along with the opportunity for investors to buy safe parts tokens, or real estate safe parts tokens, or any safe part token of any class of asset, equivalent to shares of a fund and representing a portion of a pool of safe parts allowing them to benefit from the senior tranche of yield or from the valuation of assets, they could also acquire cryptocurrency coins or utility coins that would be registered on a specific blockchain or on an existing one and be hosted on a wallet.

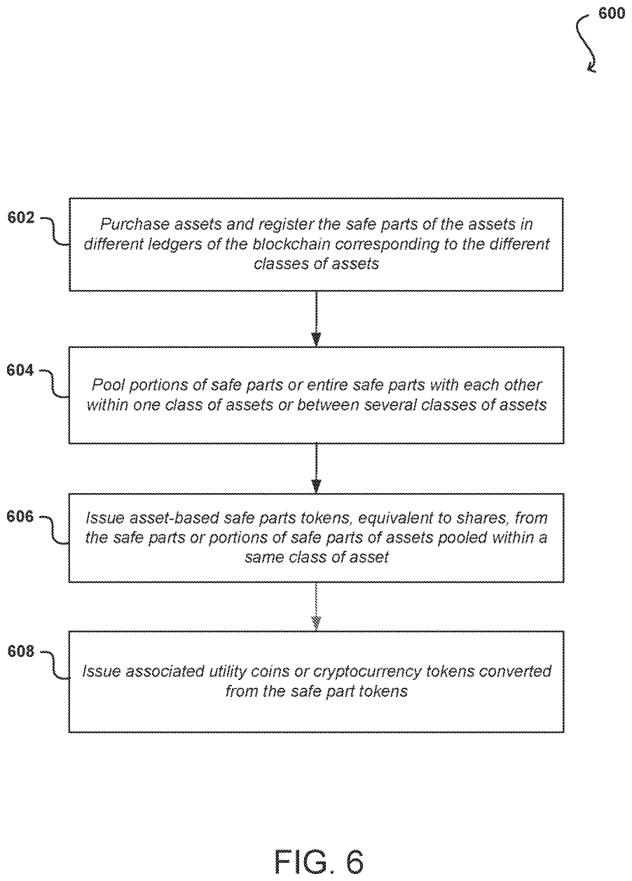

FIG. 6 illustrates an example process 600 for issuing asset-based investment products. Often, coin issuance can occur after one or more assets are bought, such as by a controlling entity, and the safe parts are identified and registered in the blockchain with one or more of the steps detailed earlier 602. Once the safe parts of assets are identified and registered in different ledgers of the blockchain corresponding to the different classes of assets, portions of safe parts or entire safe parts can be pooled with each other within one class of assets or between several classes of assets 604. Then, safe parts tokens, equivalent to shares, may be issued from the safe parts or portions of safe parts of assets pooled within a same class of asset 606. Utility coins or any other cryptocurrency token forms that could be used and created, such as by a controlling entity, may be issued at this stage of the process 608, even if there is only one class of asset available at the time of issuance of the coins.

Utility coins or another cryptocurrency token form that could be used and created, such as by a controlling entity, would be created after the conversion of an equivalent portion of “safe parts” of each class of asset registered in the blockchain to purchase the utility coin. In certain embodiments, some specific coins could also be created for a specific class of assets, and could be clearly identified as different coins dedicated to this class of asset and distinct from the coins issued from the conversion of safe part tokens relying on all classes of assets. The controlling entity, or another party, could also create safe parts tokens, equivalent to shares, relying on the valuation of several classes of assets that would benefit from a clear and specific valuation compared to the safe part tokens issued within one specific class of assets, in order for example to diversify their investment portfolio.

Safe part tokens could be sold by a fund while utility coins could be sold by another party, such as a controlling entity, directly to the owners of the safe part tokens, equivalent to shares, after they convert the tokens value into utility coins. Another possibility to sell utility coins would be to offer them on a website or marketplace, which could also take the form of an electronic application or any adapted digital support, if authorized by financial authorities. Utility coins could also be made available on authorized third parties websites and exchange platforms, specific market places, or any financial market, bank or stock exchange, physical or digital platforms with which an agreement is officialized. At the beginning of the sale process, it is highly probable that safe part tokens identified in the blockchain would be sold by a fund, such as a special limited partnership or any other form, and take the form of shares or tokens issued by the fund.

Safe parts tokens representing shares of the fund and utility coins that would be created if the shares are transformed into coins, may provide certain distinct rights. When the safe parts tokens are converted into coins, the shares are withdrawn from the fund and only the safe parts of assets and assets remain in the fund, such as under the management of a controlling entity. In some embodiments, when the shares are converted they no longer exist as such and they no longer provide dividends or valuation. This allows for the creation of cryptocurrency coins that will protect their holders from devaluation and facilitate low transaction fees.

A coin can only be issued when a safe part token holder decides to convert all or part of its safe part token portfolio, equivalent to a shares portfolio, into cryptocurrency coins. The safe part token holder would be able to convert all or part of their safe part token portfolio and can either be any investor or the controlling entity.

Another option for an external investor to acquire a utility coin would be to pay for it on Centralized Exchange (CEX) or Decentralized Exchange (DEX) marketplaces of a controlling entity or on existing CEX or DEX platforms with which an agreement is settled or on any specific market places or any financial market, bank or stock exchange, physical or digital platform with which an agreement is officialized or owned by the controlling entity.

Safe parts tokens, equivalent to shares of the fund or any other system used to sell them, would give access to dividends or valuation that can take the form of additional safe parts tokens, or shares, allocation, whereas the utility coins created through the conversion of safe parts tokens or shares may not generate dividends or additional safe parts tokens allocation. The utility coins' value would only reflect the utility coins' attractivity and the interest for the marketplace. These coins would be conceived as a cryptocurrency since they offer the ability to buy goods and services and exchange with others on different marketplaces and could also be used for physical transactions. The coins may only rely on a portfolio of safe parts tokens in a similar manner to the way fiat currencies rely on the dynamism of an economy and allow to buy and exchange goods and services. The objective of this utility coin is to offer both an innovative mean of exchange for the marketplace that would reduce transaction and exchange fees compared to the ones offered by fiat payments by using blockchain technology and funding for the structure, and to create devaluation free marketplaces that would rely both on real economic transactions and the safe part mechanisms and process described earlier, that allows to identify the “safe value” of an asset at the time it is acquired based on transparent criteria, and offer both a registration and a regular actualization of all safe parts values in the blockchain designed for the purpose. This way, coins would represent a portion of an alternative replacement currency more eager to resist to devaluation, notably by limiting the number of coins in circulation to the safe part tokens or shares converted into utility coins, and able to offer optimized exchanges on the market place owned by a controlling entity and ultimately also on any market places or any financial market, bank or stock exchange, physical transactions or digital platform with which an agreement is officialized.

In certain embodiments, certain similarities and differences exist between safe parts tokens and coins. For example, both safe parts tokens and coins can only be issued when a safe part has been registered in the blockchain as described previously. Safe parts tokens registered as such, or as shares of the fund, will always rely on distinct and specific portions of one or more safe parts of assets from the ones converted into utility coins. Therefore, safe parts tokens and utility coins cannot rely on the same portions.

In another example, safe parts tokens valuation will rely on the average value of the safe parts of assets and of the portfolio of assets owned and managed by a controlling entity, while utility coins valuation will rely on the utility provided by the coins such as priority access or reduced exchange fees offered on marketplaces compared to transactions operated in fiat currencies. Another difference includes that an investor could choose to acquire safe part tokens “shares” offered in one specific class of asset, or safe parts, buying them in fiat currency or through a contribution in kind. For example, an investor could acquire tokens against an asset such as a real estate asset.

Another difference between safe parts tokens and coins includes that an investor could choose to invest directly in the cryptocurrency, when available, and acquire a specific number of coins at a value linked to the valuation of the cryptocurrency on the market. For example, on an exchange marketplace, such as CEX or DEX, designed by a controlling entity or on existing CEX or DEX, specific market places or any financial market, bank or stock exchange, physical or digital platforms with which an agreement is officialized, at the moment they are sold.

Investors will own safe parts tokens or coins, and a controlling entity or the fund will own the safe parts of assets, and sometime the entire asset. When selling the safe parts tokens, equivalent to shares, the controlling entity sell a right to obtain or benefit from a regular yield or from a valuation based on the number of shares or safe part tokens acquired and on the NAV, minus the management fees, without a limitation in time unless specified differently in the contract and the blockchain for some specific transactions.

When issued and bought, utility coins registered in the blockchain owned by the controlling entity can be put on a wallet functioning like a saving account.

In some embodiments, coins may also be used to buy goods and assets owned by a controlling entity and sold on a marketplace owned, presented, or offered the controlling entity, with the controlling entity acting as an intermediary on the marketplace. Coins may also be used to buy goods and services outside the marketplace wherever the coins are recognized as a mean of exchange and through any service or means of payment or distribution authorized to acquire goods and services in utility coins or through an automated conversion of the coins into fiat operated at the moment of the purchase.

In at least one embodiment, the cryptocurrency coins could be exchanged or sold against fiat currencies or other cryptocurrencies offered on a website or a marketplace owned by a controlling entity or through other authorized third party websites and services, including any platform of exchange on the market or any type of stock exchanges recognizing the coins.

The cryptocurrency coins could potentially be used to buy any type of assets or services through a digital application that would dialog with digital wallets owned or offered by the controlling entity to host the coins for the benefit of their owners or with wallets owned by the owners of the coins. Both types of wallet could potentially dialog with a blockchain owned by the controlling entity to register the transactions and insure a traceability for security purposes. This type of application and transaction may be secured by a unique security key and could allow a coin holder to buy any good or services on any known or yet to be developed support of sales or exchange of value as a fiat currency would allow the holder to do. The coins could also be exchanged and sold outside the marketplace owned by the controlling entity.

In at least one embodiment, an initial coin offering (ICO) or an initial exchange offering (IEO) could be used to distribute the coins to investors in order to allow them to access the marketplace with benefits. ICO or WO could also be used as a fundraising strategy to help develop or raise capital for a company in which the controlling entity would be a shareholder or an investor.

The value of the cryptocurrency or utility coins, offered through an ICO or a WO may initially be fixed at a value indexed at least partially on the current or future exchange rate of the safe parts tokens, equivalent to shares, or on the price of sale of the safe part tokens issued at the same time and the average yield of all safe part tokens, present or future if the ICO intervenes before the creation of safe part tokens. In certain embodiments, another factor to the utility coins value appreciation would be the ability to provide low transaction fees and to reduce the risks of fraud through the use of the blockchain technology and smart contracts that are used to operate exchanges and payments, compared to exchanges and transactions operated in fiat currency.

Another option for the controlling entity would be to organize an ICO or an WO in order to offer a priority investment on the coin issuance before the safe part tokens and the cryptocurrency coins are actually created. Investors would acquire anticipated titles of ownership of the cryptocurrency coins through smart contracts registered in the blockchain owned by the controlling entity, or through the services of an existing IEO before the actual issuance of the safe part tokens, equivalent to shares, happens, and also before they are registered in the blockchain of the fund and acquired by the controlling entity. After being acquired, those utility coins may only start to provide access to the marketplace owned by the controlling entity or to a partner marketplace once the normal process of sale and registration of the safe part tokens, equivalent to shares, by the fund has occurred.

In at least one embodiment, there may be an offer dedicated to original holders of assets. After selling an asset to the controlling entity, in part or entirely, a former holder of the asset can be offered priority in terms of investment in the safe parts tokens, or during an ICO or LEO. All or part of the value of the safe part tokens, equivalent to shares, dedicated to investment and directly issued from the asset formerly owned by the former owner of the asset could be acquired by the former owner in priority. The same process could be used for initial asset owners to acquire cryptocurrency coins.

If a controlling entity holds enough cryptocurrency on their own saving account, they could decide to offer to buy all or part of the of the original asset in cryptocurrency coins. For each safe part of an asset registered in the blockchain a specific portion of the value, expressed in safe part tokens offering a yield or cryptocurrency coins created after converting safe part tokens, could be acquired and owned by the controlling entity for investment purpose and/or as a reward for the management of the asset.

In certain embodiments, a controlling entity could be the only issuer and holder of coins registered and offered in the system. In this embodiment, only the safe parts tokens registered in the blockchain and owned by the controlling entity, or options on the future safe parts tokens owned by the controlling entity, would lead to a conversion of safe parts into utility coin. Therefore, only the safe part tokens and the portions of safe parts of asset owned by the controlling entity in each class of asset would be convertible into cryptocurrency coins that could be exchanged or sold on a Marketplace, CEX or DEX owned by or partnering with the controlling entity or on any external Marketplace, CEX or DEX on any market places, financial market, bank or stock exchange, physical transactions or digital platform with which an agreement is officialized.

The controlling entity can manage all the activities described or implied by one or more of the preceding paragraphs, the list being non-exhaustive. In at least one embodiment, the controlling entity, and companies or third parties benefiting from a specific agreement with the controlling entity to operate all or part of the process may take any number of actions regarding the related activities. For example, they may directly or indirectly buy the assets and own all, or part of, the assets and will always maintain the number and/or the value of safe parts pooled and registered in the blockchain. Therefore, when one asset is sold, it will be replaced by one or several safe parts of assets that represent at least the same value as the initial one registered in the blockchain owned by the controlling entity.

In another example, they may create an investment fund or partner with an existing investment fund in order to finance the acquisition of some assets or safe parts of assets even if the sale of safe part tokens may intervene before or at the same time as the assets or safe part of assets acquisition. This allows the controlling entity to buy them without the intermediation of a financial institution.

In yet another example, they may define and administrate the investment policy of the assets and “safe parts” of assets pooled or delegate it to partners, subcontractors, or third parties.

They may also create, use, or design any number of specific blockchains or partner with existing blockchains or protocols in order to perform any number of related activities. For example, they may create ledgers needed to store, register, and authenticate each safe part of asset characteristics and the assets they are linked to as well as the process of valuation and authentication used to define each safe part of asset in every class of asset. They may list and issue safe parts tokens and coins, their characteristics and their ownership information, in compliance with data privacy laws. They may store smart contracts and any type of contract linked to the entire process of acquisition, registration, management, and sale of the safe parts tokens and coins. They may store data linked to the identity of the holders of safe parts tokens and coins, their past and present value and the number of safe parts tokens and coins issued and available. They may create and store safe part tokens and coins or to dialogue with other IT systems created or used by the controlling entity to create, issue, store, and sell the safe part tokens and coins. They may connect with electronic applications that may be developed to allow investors to use coins or the safe parts tokens, including the savings wallet.

Blockchains used by the controlling entity may be developed specifically and function with a specific code defined and developed for the creation, management and allocation of cryptocurrency tokens or coins. In another example, the blockchains may be based on existing blockchain protocols and tokens like Ethereum or any other suitable alternative. Various other IT processes can be integrated as well as would be apparent to one of ordinary skill in the art in light of the teachings and suggestions contained herein. In at least one embodiment, the controlling entity may issue different classes of safe parts tokens corresponding to different classes of assets and create or use all the information systems needed to host, sell, valorize and protect the safe part tokens or coins registered in the blockchain. In another example, the controlling entity may be in charge of managing the asset valuation on the market, such as rental, sale of the asse, etc., in order to generate yields or valuation for the safe parts tokens and might create new entities or companies to do so or partner with subcontractors or existing companies specialized in these activities. In yet another example, the controlling entity may be in charge of managing the safe part tokens or coins valuation on the market, or any type of investment created out of the safe parts of assets. The controlling entity may coordinate all legal activities needed at each part of the process. The controlling entity may create another suitable entity dedicated to formalizing and administrating trusts or French fiduciae or directly act as a fiduciary or a professional trustee to do so, in order to acquire the assets. They might also create a real estate company or any form of company that would allow them to acquire the assets or safe part of assets, in different sectors or classes of assets.

Using the required IT processes, the controlling entity may create a Special Limited Partnership (SLP) or any other type of fund adapted in order to acquire the assets that would remain the property of the fund and finance their acquisition. This process may be performed through, in certain embodiments, the sale of shares or safe parts tokens to investors that would allow them to finance the safe part of assets or in some situations the bare-ownership of assets. These tokens would represent a portion of all the safe parts of the assets portfolio, on a specific class of asset or of all assets depending on the strategy, and their value would rely on the value of the safe part of the entire assets' portfolio, or its equivalent defined by contract and registered in the blockchain. In certain embodiments, allowing investors to finance and acquire safe part tokens, equivalent to shares, through a payment in kind against the value of their assets that would become the definitive property of the fund. For example, an investor eligible to invest in the SLP could decide to convert its real estate assets into safe part tokens, equivalent to shares. In certain embodiments, the possible conclusion of multi-year loans allowing the fund or its branches to complete the financing of the asset acquisition or of the “unsafe” parts of assets, against a right of usufruct equivalent to the duration of the loan. In certain embodiments, using a vendor credit system to acquire the unsafe parts of the assets with a branch of the fund and create a real distinction from the safe parts tokens financing.

Additionally, the partnership or fund may also be used to create shares of the fund or safe parts tokens based on the safe part of assets identification and valuation process previously described, where the allocation of safe part tokens valuation or yield may be linked to a multi-year schedule and a lock-up period that would allow the investors to benefit each year from a portion of the valuation. Also, the fund may remain opened indefinitely to support the value of the safe parts tokens and allow the investors to exchange them.

The controlling entity may use a dedicated website platform or marketplace in order to provide required services, including advertising and offering needed information to the asset owners willing to sell their assets to the asset holder and its beneficiaries, in order to acquire assets, such as movables and immovables properties or any other suitable asset. In order to provide the required services and also to manage the sale process of safe part tokens and coins, the processes may require the use of customer relationship management (CRM), social networks, information system to store required data linked to the blockchain protocols developed or used to register, store, manage, and/or sale the safe part tokens and coins. The asset holder and its beneficiaries may also use salespersons or any authorized third party agent, representative, or company to interact with prospective clients and investors and existing clients and investors.

The controlling entity may create or partner with marketplaces designed to sell assets and able to communicate with the ledgers storing all ownership and authenticity information of the safe parts of assets and the characteristics of the initial assets in the blockchain owned or used by the controlling entity. In another example, the controlling entity may create a specific entity or partner with existing registered financial institutions, such as a bank, in order to offer different types of loans, lines of credit, asset-backed loans, or securities, among other such options, using the existence of the safe parts tokens or coins, and to develop and promote the wallet application usable to acquire any type of goods and services with the cryptocurrency coins. The controlling entity may also use existing blockchain protocols to offer lending, borrowing, and savings services or to develop new ones.

In one or more embodiments, a computerized environment such as that in FIG. 1 may include various resources that can be utilized by users for a variety of purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In one or more embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In one example the provider environment includes a plurality of resources of one or more types. These types can include, for example, application servers operable to process instructions provided by a user or database servers operable to process data stored in one or more data stores in response to a user request. As known for such purposes, a user can also reserve at least a portion of the data storage in a given data store. Methods for enabling a user to reserve various resources and resource instances are well known in the art, such that detailed description of the entire process, and explanation of all possible components, will not be discussed in detail herein.

A resource manager, or another such system or service, in this example can also function as a virtual layer of hardware and software components that handles control functions in addition to management actions, as may include provisioning, scaling, replication, etc. The resource manager can utilize dedicated APIs in the interface layer, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer in at least one embodiment includes a scalable set of user-facing servers that can provide the various APIs and return the appropriate responses based on the API specifications. The interface layer also can include at least one API service layer that in one embodiment consists of stateless, replicated servers which process the externally-facing user

APIs. The interface layer can be responsible for Web service front end features such as authenticating users based on credentials, authorizing the user, throttling user requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, users of the control service. The servers of the Web services layer can be stateless and scaled horizontally as known in the art. API servers, as well as the persistent data store, can be spread across multiple data centers in a region, for example, such that the servers are resilient to single data center failures.

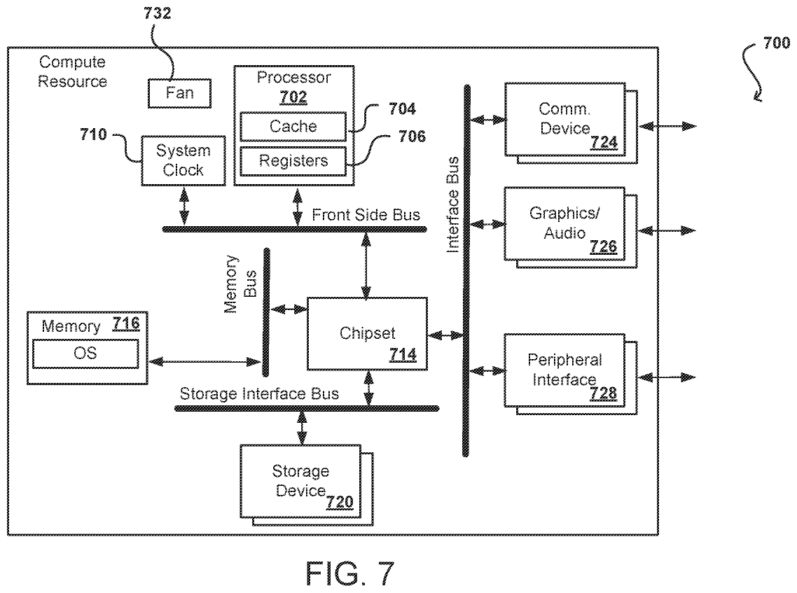

Computing resources, such as servers or personal computers, will generally include at least a set of standard components configured for general purpose operation, although various proprietary components and configurations can be used as well within the scope of the various embodiments. FIG. 7 illustrates components of an example computing resource 700 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 700 (e.g., a desktop or network server) will have one or more processors 702, such as central processing units (CPUs), graphics processing units (GPUs), and the like, that are electronically and/or communicatively coupled with various components using various buses, traces, and other such mechanisms. A processor 702 can include memory registers 706 and cache memory 704 for holding instructions, data, and the like. In this example, a chipset 714, which can include a northbridge and southbridge in some embodiments, can work with the various system buses to connect the processor 702 to components such as system memory 716, in the form or physical RAM or ROM, which can include the code for the operating system as well as various other instructions and data utilized for operation of the computing device. The computing device can also contain, or communicate through a storage interface bus with, one or more storage devices 720, such as hard drives, flash drives, optical storage, and the like, for persisting data and instructions similar, or in addition to, those stored in the processor and memory. The processor 702 can also communicate with various other components via the chipset 714 and an interface bus (or graphics bus, etc.), where those components can include communications devices 724 such as cellular modems or network cards, media components 726, such as graphics cards and audio components, and peripheral interfaces 728 for connecting peripheral devices, such as printers, keyboards, and the like. At least one cooling fan 732 or other such temperature-regulating or reduction component can also be included as well, which can be driven by the processor or triggered by various other sensors or components on, or remote from, the device. A system clock 710 may also be connected with the processor 702 and the chipset 714 through the front side bus. Various other or alternative components and configurations can be utilized as well as known in the art for computing devices.

At least one processor 702 can obtain data from physical memory 716, such as a dynamic random access memory (DRAM) module, via a coherency fabric in some embodiments.

It should be understood that various architectures can be utilized for such a computing device, that may include varying selections, numbers, and arguments of buses and bridges within the scope of the various embodiments. The data in memory may be managed and accessed by a memory controller, such as a DDR controller, through the coherency fabric. The data may be temporarily stored in a processor cache 704 in at least some embodiments. The computing device 700 can also support multiple I/O devices using a set of I/O controllers connected via an I/O bus. There may be I/O controllers to support respective types of I/O devices, such as a universal serial bus (USB) device, data storage (e.g., flash or disk storage), a network card, a peripheral component interconnect express (PCIe) card or interface 728, a communication device 724, a graphics or audio card 726, and a direct memory access (DMA) card, among other such options. In some embodiments, components such as the processor, controllers, and caches can be configured on a single card, board, or chip (i.e., a system-on-chip implementation), while in other embodiments at least some of the components may be located in different locations, etc.

An operating system (OS) running on the processor 702 can help to manage the various devices that may be utilized to provide input to be processed. This can include, for example, utilizing relevant device drivers to enable interaction with various I/O devices, where those devices may relate to data storage, device communications, user interfaces, and the like. The various I/O devices will typically connect via various device ports and communicate with the processor and other device components over one or more buses. There can be specific types of buses that provide for communications according to specific protocols, as may include peripheral component interconnect) PCI or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Such a device may be used, for example, as a server in a server farm or data warehouse. Server computers often have a need to perform tasks outside the environment of the CPU and main memory (i.e., RAM). For example, the server may need to communicate with external entities (e.g., other servers) or process data using an external processor (e.g., a General Purpose Graphical Processing Unit (GPGPU)). In such cases, the CPU may interface with one or more devices. In sonic cases, these I/O devices may be special-purpose hardware designed to perform a specific role. For example, an Ethernet network interface controller (NIC) may be implemented as an application specific integrated circuit (ARC) comprising digital logic operable to send and receive messages, such as datagrams.

In an illustrative embodiment, a host computing device is associated with various hardware components, software components and respective configurations that facilitate the execution of I/O requests. One such component is an I/O adapter that inputs and/or outputs data.

along a communication channel. in one aspect, the adapter device can communicate as a standard bridge component for facilitating access between various physical and emulated components and a communication channel. In another aspect, the I/O adapter device can include embedded microprocessors to allow the I/O adapter device to execute computer executable instructions related to the implementation of management functions or the management of one or more such management functions, or to execute other computer executable instructions related to the implementation of the I/O adapter device. in some embodiments, the I/O adapter device may be implemented using multiple discrete hardware elements, such as multiple cards or other devices. A management controller can be configured in such a way to be electrically isolated from any other component in the host device other than the I/O adapter device. in some embodiments, the I/O adapter device is attached externally to the host device. In some embodiments, the I/O adapter device is internally integrated into the host device. Also in communication with the I/O adapter device may be an external communication port component for establishing communication channels between the host device and one or more network-based services or other network-attached or direct-attached computing devices. Illustratively, the external communication port component can correspond to a network switch, sometimes known as a Top of Rack (“TOR”) switch. The I/O adapter device can utilize the external communication port component to maintain communication channels between one or more services and the host device, such as health check services, financial services, and the like.

The I/O adapter device can also be in communication with a Basic Input/Output System (BIOS) component. The BIOS component can include non-transitory executable code, often referred to as firmware, which can be executed by one or more processors and used to cause components of the host device to initialize and identify system devices such as the video display card, keyboard and mouse, hard disk drive, optical disc drive and other hardware. The BIOS component can also include or locate boot loader software that will be utilized to boot the host device. For example, in one embodiment, the BIOS component can include executable code that, when executed by a processor, causes the host device to attempt to locate Prehoot Execution Environment (PXE) boot software. Additionally, the BIOS component can include or takes the benefit of a hardware latch that is electrically controlled by the I/O adapter device. The hardware latch can restrict access to one or more aspects of the BIOS component, such controlling modifications or configurations of the executable code maintained in the BIOS component. The BIOS component can be connected to (or in communication with) a number of additional computing device resources components, such as processors, memory, and the like. In one embodiment, such computing device resource components may be physical computing device resources in communication with other components via the communication channel. The communication channel can correspond to one or more communication buses, such as a shared bus (e.g., a front side bus, a memory bus), a point-to-point bus such as a PCI or PCI Express bus, etc., in which the components of the bare metal host device communicate. Other types of communication channels, communication media, communication buses or communication protocols (e.g., the Ethernet communication protocol) may also be utilized. Additionally, in other embodiments, one or more of the computing device resource components may be virtualized hardware components emulated by the host device. In such embodiments, the I/O adapter device can implement a management process in which a host device is configured with physical or emulated hardware components based on a variety of criteria. The computing device resource components may be in communication with the I/O adapter device via the communication channel. In addition, a communication channel may connect a PCI Express device to a CPU via a northbridge or host bridge, among other such options.

In communication with the I/O adapter device via the communication channel may be one or more controller components for managing hard drives or other forms of memory. An example of a controller component can be a SATA hard drive controller. Similar to the BIOS component, the controller components can include or take the benefit of a hardware latch that is electrically controlled by the I/O adapter device. The hardware latch can restrict access to one or more aspects of the controller component. Illustratively, the hardware latches may be controlled together or independently. For example, the 110 adapter device may selectively close a hardware latch for one or more components based on a trust level associated with a particular user. In another example, the 110 adapter device may selectively close a hardware latch for one or more components based on a trust level associated with an author or distributor of the executable code to be executed by the I/O adapter device. In a further example, the I/O adapter device may selectively close a hardware latch for one or more components based on a trust level associated with the component itself. The host device can also include additional components that are in communication with one or more of the illustrative components associated with the host device. Such components can include devices, such as one or more controllers in combination with one or more peripheral devices, such as hard disks or other storage devices. Additionally, the additional components of the host device can include another set of peripheral devices, such as Graphics Processing Units (“GPUs”). The peripheral devices and can also be associated with hardware latches for restricting access to one or more aspects of the component. As mentioned above, in one embodiment, the hardware latches may be controlled together or independently.

As discussed, different approaches can be implemented in various environments in accordance with the described embodiments. As will be appreciated, although a network- or Web-based environment is used for purposes of explanation in several examples presented herein, different environments may be used, as appropriate, to implement various embodiments. Such a system can include at least one electronic client device, which can include any appropriate device operable to send and receive requests, messages or information over an appropriate network and convey information back to a user of the device. Examples of such client devices include personal computers, cell phones, handheld messaging devices, smartphones, tablets, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes at least one application server and a data store. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. The data store is also shown to include a mechanism for storing log or session data. It should be understood that there can be many other aspects that may need to be stored in the data store, such as page image information and access rights information, which can be stored in any of the above listed mechanisms as appropriate or in additional mechanisms in the data store. The data store is operable, through logic associated therewith, to receive instructions from the application server and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

In embodiments utilizing a server, the server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

At least one embodiment of the disclosure can be described in view of the following clauses:

1. A system, comprising:
one or more processors to perform one or more operations to:
identify at least one asset over which an entity has control; cause information determined for the at least one asset to be recorded to one or more distributed ledgers;
determine, from among the at least one asset, one or more portions having a risk determined to be below a specified risk threshold;
aggregate the one or more portions into a secure asset to base the asset-based investment product;
allow one or more interests to be obtained with respect to the asset-based investment product; and
cause one or more entries to be recorded to the one or more distributed ledgers to identify the one or more interests in the asset-based investment product.

2. The system of claim 1, wherein the one or more distributed ledgers are blockchains.

3. The system of claim 1, further comprising: update the one or more entries recorded to the one or more distributed ledgers as the one or more interests change.

4. The system of claim 1 further comprising:
cause descriptions of the one or more portions having a risk determined to be below a specified risk threshold to be recorded to the one or more distributed ledgers based on asset classes of the one or more portions.

5. The system of claim 1, further comprising:
assign a value to the one or more portions having a risk determined to be below a specified risk threshold.

6. The system of claim 1, wherein the one or more distributed ledgers are made available for examination.

7. A method, comprising:
identifying at least one asset over which an entity has control;
causing information determined for the at least one asset to be recorded to one or more distributed ledgers;
determining, from among the at least one asset, one or more portions having a risk determined to be below a specified risk threshold;
aggregating the one or more portions into a secure asset to base the asset-based investment product;
allowing one or more interests to be obtained with respect to the asset-based investment product; and
causing one or more entries to be recorded to the one or more distributed ledgers to identify the one or more interests in the asset-based investment product.

8. The method of claim 7, wherein the information contains at least one of authenticity, ownership, condition, service history, and market value.

9. The method of claim 7, further comprising:
authenticating, at least in part, the information recorded to the one or more distributed ledgers.

10. The method of claim 7, further comprising:
identifying, based at least in part on the obtained one or more interests, a value of the one or more portions having a risk determined to be below a specified risk threshold.

11. The method of claim 10, further comprising:
determining, based at least in part on the value of the one or more portions having a risk determined to be below a specified risk threshold, ownership level of the one or more portions and price of an equity investment.

12. The method of claim 10, further comprising:
developing, based at least in part on the value of the one or more portions having a risk determined to be below a specified risk threshold, a revenue-based financing offer.

13. A non-transitory, computer-readable storage medium storing instructions that, when executed by one or more processors, cause the one or more processors to:
identify at least one asset over which an entity has control;
cause information determined for the at least one asset to be recorded to one or more distributed ledgers;
determine, from among the at least one asset, one or more portions having a risk determined to be below a specified risk threshold;
aggregate the one or more portions into a secure asset to base the asset-based investment product;
allow one or more interests to be obtained with respect to the asset-based investment product; and
cause one or more entries to be recorded to the one or more distributed ledgers to identify the one or more interests in the asset-based investment product.

14. The method of claim 13, further comprising:
cause descriptions of the at least one asset to be recorded to the one or more distributed ledgers.

15. The method of claim 14, wherein the one or more distributed ledgers include one or more blockchains.

16. The method of claim 14, further comprising:
update the descriptions of the at least one asset recorded in the one or more distributed ledgers based on changes to the at least one asset.

17. The method of claim 13, further comprising:
assign a value to the one or more portions having a risk determined to be below a specified risk threshold.

18. The method of claim 13, further comprising:
cause a plurality of utility coins to be recorded in the one or more distributed ledgers, wherein the plurality of utility coins are created upon withdrawal of on the one or more interests.

19. The method of claim 18, wherein the plurality of utility coins are configured for transactions through one or more secure applications.

20. The method of claim 13, wherein the one or more interests are configured to be sold on a marketplace.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system, comprising:
one or more processors to perform one or more operations to:
identify at least one asset over which an entity has control;
cause information determined for the at least one asset to be recorded to one or more distributed ledgers;
determine, from among the at least one asset, one or more portions having a risk determined to be below a specified risk threshold;
aggregate the one or more portions into a secure asset to base the asset-based investment product;
allow one or more interests to be obtained with respect to the asset-based investment product; and
cause one or more entries to be recorded to the one or more distributed ledgers to identify the one or more interests in the asset-based investment product.

2. The system of claim 1, wherein the one or more distributed ledgers are blockchains.

3. The system of claim 1, further comprising:
update the one or more entries recorded to the one or more distributed ledgers as the one or more interests change.

4. The system of claim 1 further comprising:
cause descriptions of the one or more portions having a risk determined to be below a specified risk threshold to be recorded to the one or more distributed ledgers based on asset classes of the one or more portions.

5. The system of claim 1, further comprising:
assign a value to the one or more portions having a risk determined to be below a specified risk threshold.

6. The system of claim 1, wherein the one or more distributed ledgers are made available for examination.

7. A method, comprising:
identifying at least one asset over which an entity has control;
causing information determined for the at least one asset to be recorded to one or more distributed ledgers;
determining, from among the at least one asset, one or more portions having a risk determined to be below a specified risk threshold;
aggregating the one or more portions into a secure asset to base the asset-based investment product;
allowing one or more interests to be obtained with respect to the asset-based investment product; and
causing one or more entries to be recorded to the one or more distributed ledgers to identify the one or more interests in the asset-based investment product.

8. The method of claim 7, wherein the information contains at least one of authenticity, ownership, condition, service history, and market value.

9. The method of claim 7, further comprising:
authenticating, at least in part, the information recorded to the one or more distributed ledgers.

10. The method of claim 7, further comprising:
identifying, based at least in part on the obtained one or more interests, a value of the one or more portions having a risk determined to be below a specified risk threshold.

11. The method of claim 10, further comprising:
determining, based at least in part on the value of the one or more portions having a risk determined to be below a specified risk threshold, ownership level of the one or more portions and price of an equity investment.

12. The method of claim 10, further comprising:
developing, based at least in part on the value of the one or more portions having a risk determined to be below a specified risk threshold, a revenue-based financing offer.

13. A non-transitory, computer-readable storage medium storing instructions that, when executed by one or more processors, cause the one or more processors to:
identify at least one asset over which an entity has control;
cause information determined for the at least one asset to be recorded to one or more distributed ledgers;
determine, from among the at least one asset, one or more portions having a risk determined to be below a specified risk threshold;
aggregate the one or more portions into a secure asset to base the asset-based investment product;
allow one or more interests to be obtained with respect to the asset-based investment product; and
cause one or more entries to be recorded to the one or more distributed ledgers to identify the one or more interests in the asset-based investment product.

14. The method of claim 13, further comprising:
cause descriptions of the at least one asset to be recorded to the one or more distributed ledgers.

15. The method of claim 14, wherein the one or more distributed ledgers include one or more blockchains.

16. The method of claim 14, further comprising:
update the descriptions of the at least one asset recorded in the one or more distributed ledgers based on changes to the at least one asset.

17. The method of claim 13, further comprising:
assign a value to the one or more portions having a risk determined to be below a specified risk threshold.

18. The method of claim 13, further comprising:
cause a plurality of utility coins to be recorded in the one or more distributed ledgers, wherein the plurality of utility coins are created upon withdrawal of on the one or more interests.

19. The method of claim 18, wherein the plurality of utility coins are configured for transactions through one or more secure applications.

20. The method of claim 13, wherein the one or more interests are configured to be sold on a marketplace.
